(19) United States
(12) Patent Application Publication
(10) Pub. No.: US 2023/0318837 A1
(43) Pub. Date: Oct. 5, 2023

(54) Zero-Knowledge Proofs for Providing Browsing Data

(71) Applicant: OzoneAI Inc., Santa Monica, CA (US)

(72) Inventor: Lyndon Oh, Santa Monica, CA (US)

(21) Appl. No.: 17/719,681

(22) Filed: Apr. 13, 2022

Related U.S. Application Data
(60) Provisional application No. 63/324,981, filed on Mar. 29, 2022.

(51) Int. Cl. H04L 9/32; H04L 9/00

(52) U.S. Cl. CPC H04L 9/3218; H04L 9/3236; H04L 9/50; H04L 9/3247

(57) ABSTRACT

To provide information regarding user data to an organization without revealing sensitive information, user data is obtained describing one or more attributes of a user from user input, application data, or browsing data. A transaction is generated that includes the user data. The transaction is stored in a distributed ledger for decentralized file storage, where the distributed ledger is maintained by a network of participants. The transaction is transmitted to at least one other participant in the distributed ledger network, and a request is received from an organization regarding a particular attribute of the user. In response to the request, cryptographic proof of information is provided to the organization regarding the particular attribute stored in the decentralized file storage without revealing the user data.

### CROSS-REFERENCE TO RELATED APPLICATIONS

This application claims priority to and the benefit of the filing date of provisional U.S. Patent Application No. 63/324,981 entitled “Zero-Knowledge Proofs for Providing Browsing Data,” filed on Mar. 29, 2022, the entire contents of which is hereby expressly incorporated herein by reference.

### TECHNICAL FIELD

The present disclosure relates generally to privacy protection methods for sharing user data, and more particularly, to the use of distributed ledgers for secure storage of user data and zero-knowledge proofs for providing information regarding the user data without revealing sensitive information.

### BACKGROUND

Today, browsers, social media platforms, and/or other websites monetize user data by providing the user data or user data profiles to organizations such as advertisers, content publishers, game developers, entertainment platforms, etc. Users are not in control of their data, and typically cannot monetize their data or prevent their data from being shared with third parties.

### SUMMARY

To allow users to control access to their data, monetize their data, and provide information to third-party organizations about their data without revealing sensitive information, such as their home address, income, etc., a privacy-protected browsing system utilizes distributed ledgers, and more specifically, a decentralized file storage system to store user data. The browsing system may encrypt the user data and store the encrypted user data at a decentralized file storage system.

By encrypting the data and sending the encrypted data to storage centers operating as nodes of the decentralized file storage system the data is less vulnerable to an attack, because a hacker cannot obtain the raw data by gaining unauthorized access to a node of the decentralized file storage system. Moreover, the nodes maintain a distributed ledger for receiving and responding to requests to store user data. By including a distributed ledger, the nodes may provide a trusted, secure, and immutable record of user data. User data is not only stored at a single, centralized server which can be shut down, but at multiple nodes of the decentralized file storage system to ensure content persistence. Furthermore, the nodes of the decentralized file storage system periodically provide cryptographic proofs indicating that they are storing a copy of the user data and that the user data is being stored continuously to ensure that the user data is available and has not been tampered with.

In some scenarios, a user may navigate to an application or website maintained by a third-party organization via the browsing system. For example, the user may navigate to a content publisher website via a browser or while executing a browser extension. The third-party organization may provide a request regarding a particular demographic condition of the user. The user may select whether they want to respond to the request by selecting user controls presented within the browser. If the user indicates that they want to respond to the request, the browsing system may retrieve and decrypt the encrypted user data from the decentralized file storage system.

Then instead of providing the user data directly to the third-party organization which may include sensitive information, the browsing system provides a response to the request with cryptographic proof that the user satisfies the demographic condition. For example, if the demographic condition is whether the user is a homeowner, the browsing system may utilize the user data to provide cryptographic proof that the user owns a home without providing the user's address. In another example, the demographic condition may be an income range such as an annual income of at least $50,000. The browsing system may utilize the user data to provide cryptographic proof that the user makes at least $50,000 a year without providing the user's annual income. In yet another example, the third-party organization may simply request that a user has data related to a particular demographic condition. The browsing system may utilize the user data to provide cryptographic proof that the user possesses the relevant data without providing such data. The browsing system may provide cryptographic proof of information through a zero-knowledge proof, described in more detail below.

In this manner, the browsing system allows users to share and monetize their data in a way that also protects their privacy. By providing cryptographic proofs of particular user attributes or demographic conditions without revealing the underlying user data, the browsing system prevents third-party organizations from accessing sensitive information. This also improves cybersecurity relative to other browsing systems by preventing third-party organizations, which may be vulnerable to attacks from hackers, from storing sensitive information.

In some implementations, in response to responding to the request, the third-party organization may provide compensation to the user, for example, in the form of a digital token. In other implementations, the browsing service provides a digital token to the user, by for example, sending the digital token to an address maintained by a digital wallet application executing on the user's client device. In yet other implementations, a smart contract may facilitate the exchange of information related to user data for a digital token.

One example embodiment of the techniques of this disclosure is a method for providing information regarding user data to an organization without revealing sensitive information. The method includes obtaining user data describing one or more attributes of a user from user input, application data, or browsing data, and generating a transaction including the user data. The transaction is stored in a distributed ledger for decentralized file storage, and the distributed ledger is maintained by a network of participants. The method also includes transmitting the transaction to at least one other participant in the distributed ledger network, and receiving a request from an organization regarding a particular attribute of the user. In response to the request, the method includes providing, to the organization, cryptographic proof of information regarding the particular attribute stored in the decentralized file storage without revealing the user data.

Another example embodiment of the techniques of this disclosure is a computing device for providing information regarding user data to an organization without revealing sensitive information. The computing device includes one or more processors, and a non-transitory computer-readable medium coupled to the one or more processors and storing instructions thereon. When executed by the one or more processors, the instructions cause the computing device to obtain user data describing one or more attributes of a user from user input, application data, or browsing data, and generate a transaction including the user data. The transaction is stored in a distributed ledger for decentralized file storage, and the distributed ledger is maintained by a network of participants. The instructions also cause the computing device to transmit the transaction to at least one other participant in the distributed ledger network, and receive a request from an organization regarding a particular attribute of the user. In response to the request, the instructions cause the computing device to provide, to the organization, cryptographic proof of information regarding the particular attribute stored in the decentralized file storage without revealing the user data.

Yet another example embodiment of the techniques of this disclosure is a non-transitory computer-readable medium coupled to one or more processors and storing instructions thereon. When executed by the one or more processors, the instructions cause the one or more processors to obtain user data describing one or more attributes of a user from user input, application data, or browsing data, and generate a transaction including the user data. The transaction is stored in a distributed ledger for decentralized file storage, and the distributed ledger is maintained by a network of participants. The instructions also cause the one or more processors to transmit the transaction to at least one other participant in the distributed ledger network, and receive a request from an organization regarding a particular attribute of the user. In response to the request, the instructions cause the one or more processors to provide, to the organization, cryptographic proof of information regarding the particular attribute stored in the decentralized file storage without revealing the user data.

### BRIEF DESCRIPTION OF THE DRAWINGS

FIG. 1 illustrates a block diagram of a computer network and system on which a privacy-protected browsing system may operate in accordance with an example aspect of the present disclosure;

FIG. 2 is an exemplary distributed ledger system for recording transactions and executing smart contracts in a decentralized file storage system;

FIG. 3 illustrates exemplary validating network nodes and an exemplary transaction flow on a distributed ledger network in a decentralized file storage system;

FIG. 4 illustrates exemplary components of a network node on a distributed ledger network in a decentralized file storage system;

FIG. 5 illustrates an example transaction for a request to store user data which is included in a blockchain;

FIG. 6 illustrates an example combined block and message diagram illustrating the components of the privacy-protected browsing system and interactions between the components;

FIG. 7 is a message diagram illustrating an example interaction between a third-party organization, a client device, and a distributed ledger for providing an attribute of a user without revealing sensitive information;

FIG. 8 is a message diagram illustrating an example interaction between a third-party organization, a client device, a browsing server, and a distributed ledger for providing an attribute of a user without revealing sensitive information; and

FIG. 9 illustrates a flow diagram representing an exemplary method for providing information regarding user data to an organization without revealing sensitive information.

### DETAILED DESCRIPTION

A distributed ledger is a storage mechanism for data, events, transactions, etc. that is maintained by several participants. More specifically, a distributed ledger is a way of achieving a distributed consensus on the validity or invalidity of information recorded in the distributed ledger. In other words, the distributed ledger provides a decentralized trust to participants and observers. As opposed to relying on a central authority, a distributed ledger is a decentralized database in which a transactional record of changes to the ledger is maintained and validated by each node of a peer-to-peer network. One type of distributed ledger, a blockchain, is comprised of groupings of transactions organized together into a “block,” and ordered sequentially (thus the term “blockchain”). While the distributed ledgers discussed herein are referred to in the context of a blockchain, this is merely one example of a distributed ledger. Distributed ledgers may also include a tangle, a block lattice, or other directed acyclic graph (DAG). In any event, nodes may join and leave the blockchain network over time and may obtain blocks from peer nodes that were propagated while the node was gone. Nodes may maintain addresses of other nodes and exchange addresses of known nodes with one another to facilitate the propagation of new information across the network in a decentralized, peer-to-peer manner.

The nodes that share the ledger form what is referred to herein as the distributed ledger network. The nodes in the distributed ledger network validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. A consensus rule may require that blocks and transactions adhere to format requirements and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

Additions to the blockchain that satisfy the consensus rules are propagated from nodes that have validated the addition to other nodes that the validating node is aware of. If all of the nodes that receive a change to the blockchain validate the new block, then the distributed ledger reflects the new change as stored on all nodes, and it may be said that distributed consensus has been reached with respect to the new block and the information contained therein. Any change that does not satisfy the consensus rule is disregarded by validating nodes that receive the change and the change is not propagated to other nodes. Accordingly, unlike a traditional system which uses a central authority, a single party cannot unilaterally alter the distributed ledger unless the single party can do so in a way that satisfies the consensus rules. The inability to modify past transactions leads to blockchains being generally described as trusted, secure, and immutable.

The validation activities of nodes applying consensus rules on a blockchain network may take various forms. In one implementation, the blockchain may be viewed as a shared spreadsheet that tracks data such as the ownership of assets. In another implementation, the validating nodes execute code contained in “smart contracts” and distributed consensus is expressed as the network nodes agreeing on the output of the executed code.

A smart contract is a computer protocol that enables the automatic execution and/or enforcement of an agreement between different parties. In particular, the smart contract may be computer code that is located at a particular address on the blockchain. In some cases the smart contract may run automatically in response to a participant in the blockchain sending funds (e.g., a cryptocurrency such as bitcoin, ether, or other digital/virtual currency) to the address where the smart contract is stored. Additionally, smart contracts may maintain a balance of the amount of funds that are stored at their address. In some scenarios when this balance reaches zero the smart contract may no longer be operational.

The smart contract may include one or more trigger conditions, that, when satisfied, correspond to one or more actions. For some smart contracts, the action(s) performed may be determined based upon one or more decision conditions. In some instances, data streams may be routed to the smart contract so that the smart contract may detect that a trigger condition has occurred and/or analyze a decision condition.

Blockchains may be deployed in a public, decentralized, and permissionless manner meaning that any party may view the distributed ledger, submit new information to be added to the ledger, or join the network as a validating node. Other blockchains are private (e.g., permissioned ledgers) that keep chain data private among a group of entities authorized to participate in the blockchain network. Other blockchain implementations may be both permissioned and permissionless whereby participants may need to be validated, but only the information that participants in the network wish to be public is made public.

In some implementations, a distributed ledger includes multiple blockchains such as a main blockchain and several side chains operating independently of the main blockchain. The side chains then interact with the main blockchain to provide some of the transaction data from the side chains to the main blockchain. In this manner, the side chains can be private while the main blockchain is public or available to a larger number of entities than the side chains. Non-sensitive information from the side chains may be shared on the main blockchain. Also in some implementations, a distributed ledger includes multiple layers or separate blockchains executing in parallel that are maintained by the same validating nodes. Some of the transaction data from the blockchain for the first layer may be provided to the blockchain for the second layer or vice versa.

In one example, a distributed ledger may be maintained by validating nodes which transmit data to remote systems using one or more public and/or private networks, such as a private enterprise network, the Internet, a cellular router, a backhaul Internet or other type backhaul connection. The validating nodes receive transactions broadcasted to the distributed ledger network. The validating nodes then validate the broadcasted transactions. In some implementations, the storage centers are validating nodes such that the storage centers validate broadcasted transactions.

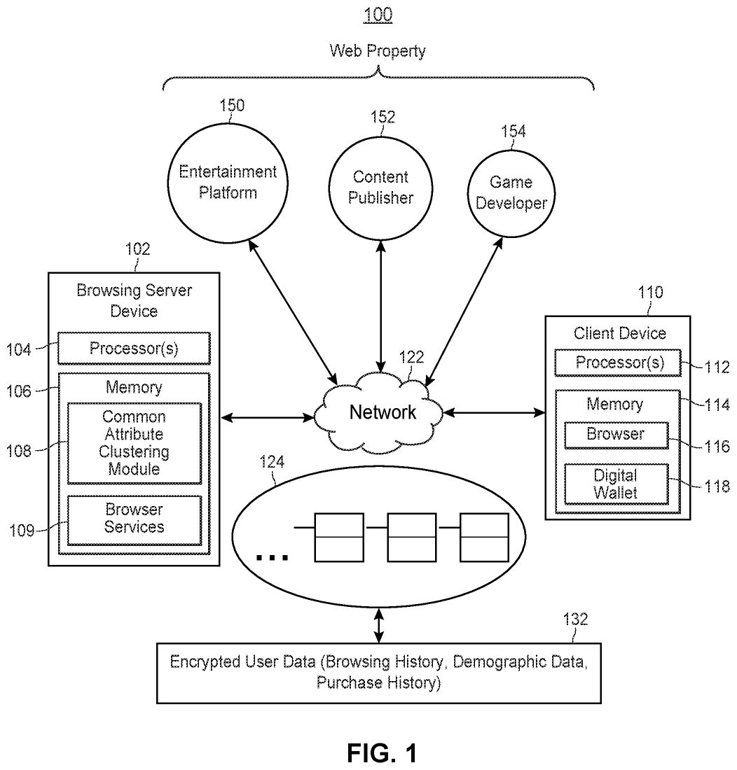

FIG. 1 illustrates various aspects of an example privacy-protected browsing system 100. The browsing system 100 may include a client device 110, a browsing server device 102, third-party organizations 150-154 providing web properties, such as entertainment platforms 150, content publishers 152, game developers 124, etc., and a distributed ledger 124 maintained by validating network nodes (not shown), which may be communicatively connected through a network 122 as described below. Web properties may include websites, blogs, applications, platforms or any other suitable web assets for an organization.

The third-party organizations 150-154 may include any organization requesting user data, such as advertisers, data analytics companies, etc. A third-party organization 150-154 may request user data in response to a user navigating to a web property provided by the organization 150-154 via a browsing application. For example, the web property may include a Software Development Kit (SDK) provided by a browsing service operating within the browsing system 100. The SDK may cause the web property to present a permissions dialog to the user requesting the user for permission to provide proof that the user has a particular attribute or satisfies a particular demographic condition.

In other scenarios, the third-party organization 150-154 may request user data in response to a user accessing the Internet via the browsing application without navigating to a web property provided by the organization 150-154.

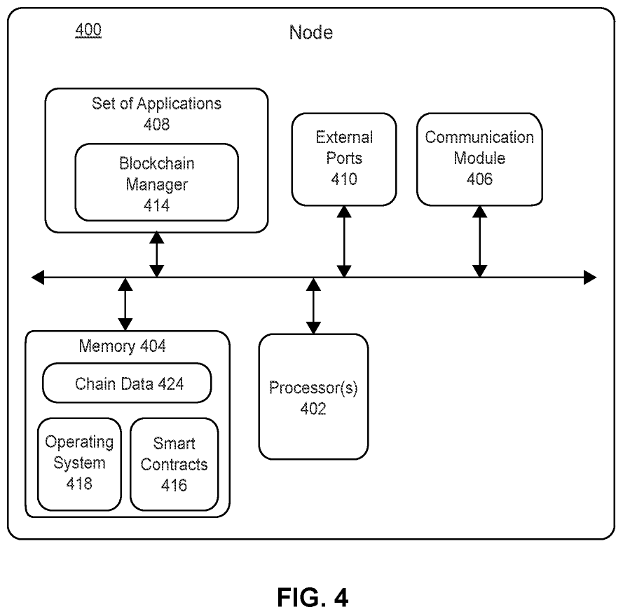

According to embodiments, the validating network nodes may be a combination of hardware and software components, also as described in more detail below with reference to FIG. 4. The validating network nodes may validate changes to the blockchain (e.g., when a new transaction and/or block is created) according to a set of consensus rules. The consensus rules depend on the information being tracked by the blockchain and may include rules regarding the chain itself. For example, a consensus rule may include that the originator of a change supply a proof-of-identity such that only approved entities may originate changes to the chain. Another consensus rule may require that blocks and transactions adhere to format requirements and supply certain meta information regarding the change (e.g., blocks must be below a size limit, transactions must include a number of fields, etc.). Consensus rules may include a mechanism to determine the order in which new blocks are added to the chain (e.g., through a proof-of-work system, proof-of-stake, etc.).

The validating network nodes may append distributed ledger data to the distributed ledger if the distributed ledger data satisfies the consensus rules by generating a new block of validated transactions to include in the distributed ledger 124 and/or by broadcasting a block of transactions to other network nodes. Otherwise, the validating network nodes disregard any distributed ledger data that does not satisfy the consensus rules, and the distributed ledger data is not propagated to other network nodes. For example, as shown in FIG. 1, the distributed ledger 124 indicates requests to store user data, such as a user's browsing history, demographic data, purchase history, etc.

The client device 110 may include, by way of example, a tablet computer, a cell phone, a personal digital assistant (PDA), a mobile device smart-phone also referred to herein as a “mobile device,” a laptop computer, a desktop computer, a portable media player, a wearable computing device, a virtual reality headset, smart glasses, a smart watch, a phablet, another smart device, a device configured for wired or wireless RF (Radio Frequency), etc. Of course, any network-enabled device appropriately configured may interact with the browsing system 100. The client device 110 need not necessarily communicate with the network 122 via a wired connection. In some instances, the client device 110 may communicate with the network 122 via wireless signals and, in some instances, may communicate with the network 122 via an intervening wireless or wired device, which may be a wireless router, a wireless repeater, a base transceiver station of a mobile telephony provider, an optical communications device, etc.

The client device 110 may include a memory 114, one or more processors 112 such as a microcontroller or a microprocessor, and other components not shown in FIG. 1 (e.g., a display, a communication unit, a user-input device, a RAM, and/or an I/O circuit), all of which may be interconnected via an address/data bus. The memory 114 may include an operating system, a data storage, a plurality of software applications, and/or a plurality of software routines. The operating system, for example, may include one of a plurality of mobile platforms such as the iOS®, Android™, Palm® webOS, Windows Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and

Nokia, respectively. The data storage may include data such as user profiles, application data for the plurality of applications, routine data for the plurality of routines, and/or other data necessary to interact with the browsing server device 102, the third-party organizations 150-154, and the distributed ledger 124 through the digital network 122. In some embodiments, the one or more processors 112 may also include, or otherwise be communicatively connected to, other data storage mechanisms (e.g., one or more hard disk drives, optical storage drives, solid state storage devices, etc.) that reside within the client device 110.

The communication unit may communicate with the browsing server device 102, the third-party organizations 150-154, and the distributed ledger 124 via any suitable wireless communication protocol network, such as a wireless telephony network (e.g., GSM, CDMA, LTE, etc.), a Wi-Fi network (802.11 standards), a WiMAX network, a Bluetooth network, etc.

The user-input device may include a “soft” keyboard that is displayed on the display of the client device 110, an external hardware keyboard communicating via a wired or a wireless connection (e.g., a Bluetooth keyboard), an external mouse, or any other suitable user-input device.

The one or more processors 112 may be adapted and configured to execute any one or more of the plurality of software applications and/or any one or more of the plurality of software routines residing in the memory, in addition to other software applications. One of the plurality of applications may be a client application that may be implemented as a series of machine-readable instructions for performing the various tasks associated with receiving information at, displaying information on, and/or transmitting information from the client device 110.

One of the plurality of applications may be a native application and/or web browser 116 that may be implemented as a series of machine-readable instructions for receiving, interpreting, and/or displaying web page information while also receiving inputs from the user. Another application of the plurality of applications may include an embedded web browser 116 or browser extension that may be implemented as a series of machine-readable instructions for receiving, interpreting, and/or displaying web page information.

One of the plurality of routines may include a browsing routine that obtains user data describing attributes of a user based on user input, application data, or browsing data, such as browsing history, purchase history, etc. The user data may include demographic data, such as the user's age, gender, address, ethnicity, nationality, income, marital status, level of education, etc. The user data may also include the user's interests or content preferences, such as shopping preferences, preferred restaurants, preferred travel destinations, preferred activities, preferred sports teams, etc. Additionally, the user data may include behavioral attributes such as whether or not the user is in-market for a given purchase category, whether or not the user is eligible for certain market transactions, the user's purchasing preferences, such as the types of goods or services the user purchases, the purchase price of the goods or services, the frequency in which the user makes purchases, the quality of the goods or services, etc. The browsing routine may obtain user data in response to the user selecting a user control providing permission to obtain user data. The user data may be obtained based on user input, such as the user interacting with user controls (e.g., a drop-down menu, a free-form text field, etc.) to enter demographic data or user preference data. The browsing routine may also obtain user data based on the user's browsing data, such as the user's purchase history, search queries, web interactions, etc. Additionally, the browsing routine may obtain user data based on application data, such as the user's interactions with various applications or web properties.

Preferably, a user may launch a browsing application 116 from a client device 110 to access the Internet and interact with online services. The user may generate user data as a result of their interactions with the online services. The browsing application 116 may encrypt the user data and provide the encrypted user data to validating network nodes of a distributed ledger network maintaining a distributed ledger 124 for a decentralized file storage system. In other implementations, the distributed ledger 124 is a permissioned distributed ledger where only authorized entities can access user data stored at the decentralized file storage system. In these implementations, the user data may not need to be encrypted since the public cannot access the user data.

In any event, when the user navigates to an web property of a third-party organization 150-154 via the browsing application 116 or another application executing on the client device 110, the organization 150-154 may provide a request for a particular attribute of the user. The particular attribute may be a demographic condition, such as whether the user is a homeowner, likes outdoor activities, has kids, etc. In some implementations, the user may provide an indication that the user wants to respond to the request, for example in exchange for a digital token, such as a cryptocurrency or other digital/virtual currency. Then the browsing application 116 may obtain and/or decrypt the user data from the decentralized file storage system. To respond to the request, the browsing application 116 may generate cryptographic proof that the user has the particular attribute or satisfies the demographic condition, for example using a zero-knowledge proof. Then the browsing application 116 may provide the cryptographic proof to the organization 150-154 without providing the user data. In some implementations, in response to providing the cryptographic proof, the client device 110 may receive a particular number of digital tokens at a distributed ledger address maintained by a digital wallet 118 executing on the client device 110 from the organization 150-154 or the browsing server device 102.

Also in some implementations, the web property may provide an initial request to the user for the particular attribute of the user (e.g., whether the user has made more than five purchases in a particular purchase category over the past year). In response, the user may grant a first level of permission (e.g., a Level 1 permission) for the web property to receive cryptographic proof that the user has the particular attribute or satisfies the demographic condition without providing the user data.

The web property may then provide a subsequent request to the user for the underlying user data which was used to generate the cryptographic proof (e.g., the number of times the user has made a purchase in the particular purchase category over the past year). In response, the use may grant a second level of permission (e.g., a Level 2 permission) for the web property to receive a piece or shard of the user data which was used to generate the cryptographic proof. The browsing application 116 may then provide the shard to the web property. A shard may refer to an atomic unit of shareable data or the smallest amount of user data which can be shared with a web property. For example, when the web property requests a particular type of user data (e.g., the user's annual income), the browsing application 116 does not provide all of the user data for the user. Instead, the browsing application 116 provides a shard of the user data that is responsive to the request (e.g., the portion of the user data that includes the user's annual income).

Although FIG. 1 illustrates the browsing application 116 as a standalone application, the functionality of the browsing application 116 also can be provided in the form of an online service accessible as a web browser executing on the client device 110, as a plug-in or extension for another software application (e.g., another browser application) executing on the client device 110, etc.

In some implementations, the browsing server device 102 may act as an intermediary between the client device 110 and the organization 150-154. The browsing server device 102 includes one or more processors 104 and a memory 106. The memory 106 may be tangible, non-transitory memory and may include any types of suitable memory modules, including random access memory (RAM), read-only memory (ROM), flash memory, other types of persistent memory, etc. The memory 106 stores instructions executable on the processors 104 that make up browser services 107 and a common attribute clustering module 108.

The browser services 107 may receive a request from an organization 150-154 for a particular attribute(s) or demographic condition(s) of users executing the browser application 116 on respective client devices 110. The browser services 107 may then provide these requests to browsing applications 116 and in turn, may receive cryptographic proofs from the browsing applications 116 of various attributes or demographic conditions.

In some implementations, the common attribute clustering module 108 may cluster the users based on the various attributes or demographic conditions that are shared amongst a cohort of the users. More specifically, the common attribute clustering module 108 may use a k-means clustering algorithm to segment the users into clusters each having a shared set of attributes or demographic conditions. For example, the common attribute clustering module 108 may identify that a cohort of 100 users executing the browser application 116 are single men under 40 years old. The browser services 107 may then provide the common set of attributes or demographic conditions for the cohort to the organization 150-154. Additionally, the browser services 107 may provide digital tokens to the users for providing proof of the attributes or demographic conditions.

In other implementations, the browsing server device 102 does not aggregate or cluster users based on shared attributes or demographic conditions. Instead, the browser services 107 may act as an intermediary between the client device 110 and the organization 150-154 by receiving a request for a particular attribute or demographic information, forwarding the request to the client device 110, receiving the cryptographic proof from the client device 110, and forwarding the cryptographic proof to the organization 150-154.

It will be appreciated that although only one client devices 110, one browsing server device 102, and three organizations 150-154 are depicted in FIG. 1, any suitable number of client devices 110, browsing server devices 102, and organizations 150-154 may be included in the browsing system 100.

The client device 110, browsing server device 102, organizations 150-154 and validating network nodes may communicate with each other via the network 122. The digital network 122 may be a proprietary network, a secure public Internet, a virtual private network and/or some other type of network, such as dedicated access lines, plain ordinary telephone lines, satellite links, a wireless telephony network, combinations of these, etc. Where the digital network 122 comprises the Internet, data communication may take place over the digital network 122 via an Internet communication protocol.

As mentioned above, when user data is generated the browsing application 116 stores the user data or an encrypted version of the user data at an address derived from a content identifier (CID) in a decentralized file storage system, such as the InterPlanetary File System (IPFS), Filecoin, a combination of these, or any other suitable decentralized file storage system. The CID may be the output of the user data being hashed according to a cryptographic hashing algorithm (e.g., SHA-256). In this manner, the CID uniquely corresponds to the user data, and if the user data is altered in any way the resulting hash will be different from the CID. The decentralized file storage system may include storage centers acting as nodes in a distributed ledger network that provide proof of replication and proof of spacetime for storing the data. Proof of replication may include a combination of a proof of space to demonstrate that the storage center is using some minimum amount of space to store a file and a proof of retrievability to demonstrate that the storage center can retrieve the file. Proof of replication proves that a given storage center is storing a physically unique copy of a user's original data, while proof of spacetime proves that the user's data is stored continuously over time. The proof of replication and proof of spacetime may be provided using zero-knowledge Succinct Non-Interactive Arguments of Knowledge (zk-SNARKs).

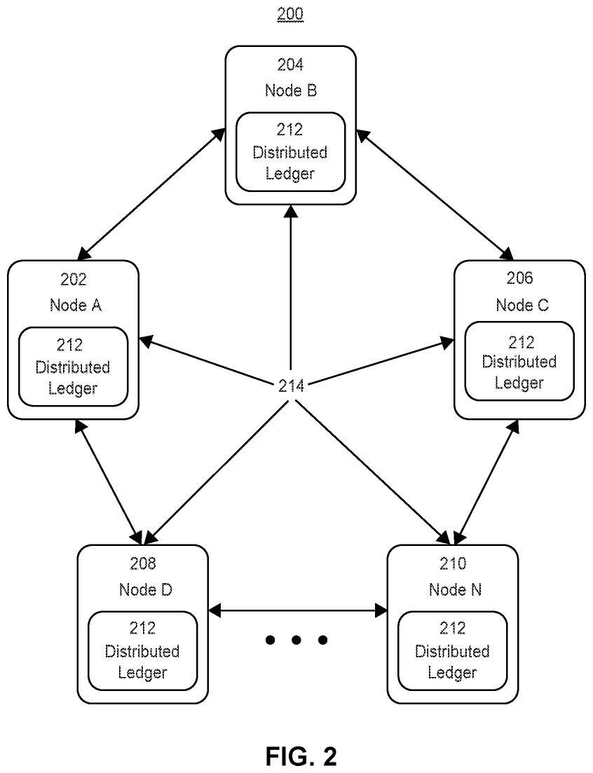

FIG. 2 depicts an exemplary distributed ledger system 200 for receiving and responding to requests to store user data. The system 200 includes a distributed ledger 212 and a plurality of nodes 202, 204, 206, 208, and 210, which may be storage centers, or may be any suitable computing devices. Each node maintains a copy of the distributed ledger 212. As changes are made to the distributed ledger 212, each node receives the change via the network 214 and updates its respective copy of the distributed ledger 212. A consensus mechanism may be used by the nodes 202-210 in the distributed ledger system 200 to decide whether it is appropriate to make received changes to the distributed ledger 212.

Each node in the system therefore has its own copy of the distributed ledger 212, which is identical to every other copy of the distributed ledger 212 stored by the other nodes. The distributed ledger system 200 may be more robust than a central authority database system because of the distributed ledger's decentralized nature. As such, there is no single point of failure on the distributed ledger system 200 as there would be in a centralized system.

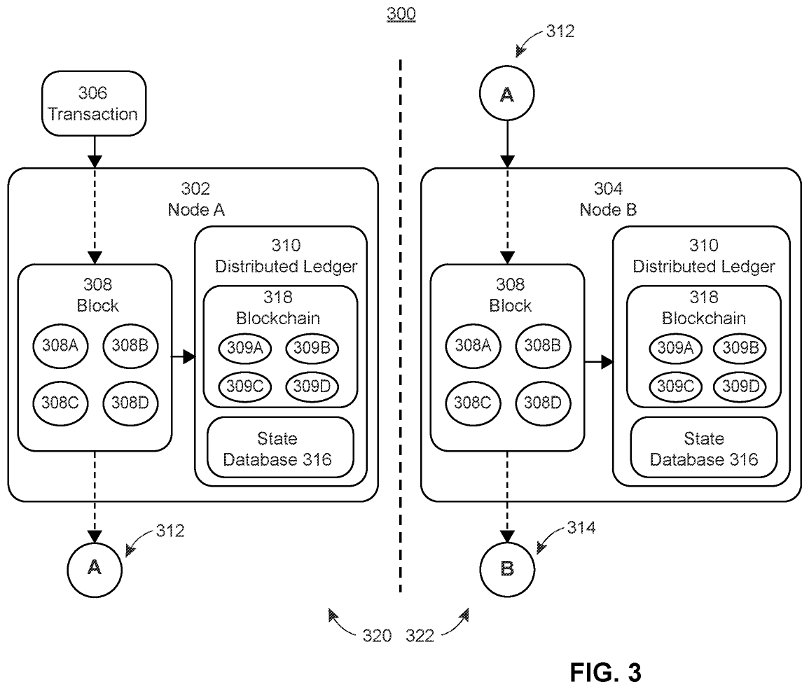

FIG. 3 depicts exemplary validating network nodes and an exemplary transaction flow 300 on a distributed ledger network for resolving transactions. FIG. 3 includes two time frames 320 and 322 represented by the left and right sides of the dotted line, respectively, Node A 302 and Node B 304 (which may be two storage centers), a set of transactions 308A-308D, a set of blocks of transactions 309A-309D, a distributed ledger 310, and a blockchain 318.

The block propagation flow 300 may begin with Node A 302 receiving transaction 306 at time 320. When Node A 302 confirms that transaction 306 is valid, Node A 302 may add the transaction to a newly generated block 308. As part of adding the transaction 306 to block 308, Node A may provide proof of replication and/or proof of spacetime as proof that Node A is storing a physically unique copy of original data and that the data is being stored continuously over time to generate the block 308. In other implementations, Node A 302 may solve a cryptographic puzzle and include the solution in the newly generated block 308 as proof of the work done to generate the block 308. Alternatively, a proof of stake algorithm may be used to generate the block 308, whereby Node A 302 “stakes” an amount of a digital token used on the network, however, the network itself determines the node that will mint the new block. In other embodiments, the transaction 306 may be added to a pool of transactions until a sufficient number of transactions in the pool exist to form a block. Node A 302 may transmit the newly created block 308 to the network at time 312. Before or after propagating the block 308, Node A 302 may add the block 308 to its copy of the blockchain 318.

While proof of replication, proof of spacetime, proof of work, and proof of stake are described herein as consensus algorithms for selecting a node to mint a new block, these are merely a few example consensus algorithms and are not intended to be limiting. Additional consensus algorithms may be utilized, such as delegated proof of stake where nodes elect a subset of nodes referred to as delegates to perform validation, and the delegates take turns minting new blocks. Consensus algorithms may also include proof of authority, proof of weight, Byzantine fault tolerance, tangle consensus algorithms, block lattice consensus algorithms, etc.

In any event, the transactions 309A-309D may include updates to a state database 316. The state database 316 may contain current values of variables created by smart contracts deployed on the blockchain 318. Validated blocks, such as block 308, may include transactions effecting state variables in state database 316. At time 322, Node B 304 may receive the newly created block 308 via the network at 312. Node B 304 may verify that the block of transactions 308 is valid by checking the proof of replication and/or proof of spacetime, or checking the solution to the cryptographic puzzle provided in the block 308. If the solution is accurate, then Node B 304 may add the block 308 to its blockchain 318 and make any updates to the state database 316 as rejected by the transactions in block 308. Node B 304 may then transmit the block 308 to the rest of the network at time 314.

FIG. 4 depicts exemplary components of a validating network node 400 on a distributed ledger network for storing user data. Node 400 may include at least one processor 402, memory 404, a communication module 406, a set of applications 408, external ports 410, a blockchain manager 414, smart contracts 416, and an operating system 418. In some embodiments, the node 400 may generate a new block of transactions, or may broadcast transactions to other network nodes by using the blockchain manager 414. Similarly, the node 400 may use the blockchain manager 414 in conjunction with the smart contracts 416 stored in the memory 404 to execute the functionality disclosed herein. The memory 404 may further include chain data 424 including, for example, a state database of the blockchain for storing states of smart contracts deployed thereon.

In other embodiments, the smart contracts 416 operate independent of the blockchain manager 414 or other applications. In some embodiments, the node 400 does not have a blockchain manager 414, or smart contracts 416 stored at the node. In some embodiments, the node 400 may have additional or fewer components than described. The components of the node 400 are described in more detail below.

In some embodiments, the blockchain includes several blocks connected together to form a chain of blocks of transactions. To cryptographically link blocks and transactions together, each block in the blockchain organizes its transactions into a Merkle Tree. In a Merkle Tree each transaction is hashed according to a cryptographic hashing algorithm (e.g., SHA-256) and the resulting output hash is then combined with the hash of another transaction. Then the combined result is also hashed according to the cryptographic hashing algorithm. This output is then combined with the hash of two other transactions and this process is repeated until all of the transactions in the block are combined and hashed to generate a Merkle root that is used in the header for a block. If any single transaction in the block is tampered with, a different Merkle root would be generated since the Merkle root is a combination of the hashes of all of the transactions in the block.

In other words, the transactions may be hashed using a cryptographic hash algorithm, such as the algorithms discussed above, and the hash of each transaction may be stored in the tree. As the tree is constructed the hash of each adjacent node at the same level may be hashed together to create a new node that exists at a higher level in the tree. Therefore, the node at the top of the tree or Merkle root, is dependent upon the hash of each transaction stored below in the tree. Each transaction may include a set of data. The set of data may include identifying data for the transaction, and transaction data identifying the nature of the transaction and what the transaction entails (e.g., input and output addresses, a transaction value, a document hash value, a timestamp, a transaction fee value, etc.).

To verify that a block is valid, a node may compare the Merkle root of the block to the Merkle root for the same block included in other nodes' copies of the blockchain. Thus, the Merkle root can be used as proof of the transactions included in the block and as proof that the contents of the block have not been tampered with if the Merkle root is the same in each node's copy of the block.

In one implementation, documents stored “on” a blockchain are documents that have been hashed according to a cryptographic hashing algorithm (e.g., SHA-256) and the resulting output hash has been included in a transaction in a block that has been accepted by the network nodes as satisfying the consensus rules of the blockchain. As such, the documents may be later verified or validated by comparing the hash of the documents to the hash stored on the blockchain. For example, if a set of documents results in a SHA-256 hash that was recorded on a blockchain on a certain date, then the blockchain provides cryptographic proof that the documents existed as of that date.

One way of storing a document on a blockchain is to broadcast a transaction including a hash of the document to the network, which will be included in a block if the transaction satisfies all of the consensus rules of the network. In some implementations, the blockchain is a permissioned ledger, meaning only authorized network participants may broadcast transactions. In other implementations, only some authorized network participants may make certain transactions. For example, user data may be uploaded to the blockchain as the encrypted user data is stored at a storage center. Only a cryptographic hash of the encrypted user data may be included in the blockchain, such that the encrypted user data may be verified using the blockchain even if it is obtained by a party off-chain.

Validating network nodes may verify that a signed transaction or signed message was signed by the private cryptographic key corresponding to the published public cryptographic key owned by the storage center storing the encrypted user data. In at least one implementation, a valid proof-of-identity may be applied as a consensus rule by the blockchain network. As such, any transaction attempting to store data without a cryptographic proof-of-identity matching an identity authorized to store data is rejected by the network as non-compliant with the consensus rule. Each storage center may be assigned a public key/private key pair which is identified in the blockchain network as corresponding to the storage center. If the validating network nodes receive a transaction including data storage information that is not from an authorized storage center, the validating network nodes reject the transaction.

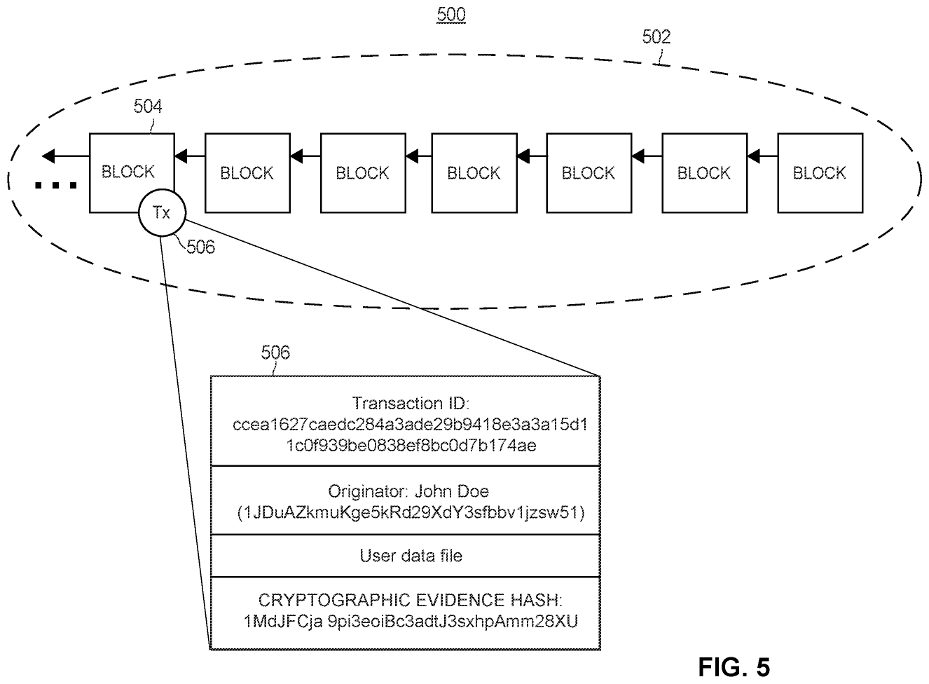

FIG. 5 illustrates an example transaction 506 representing a request to store user data generated by a user (John Doe). The user may broadcast the transaction 506, via the user's client device 110 to blockchain 502 to be included in a block, such as block 504.

The transaction 506 may include a transaction ID and an originator such as John Doe (identified by a cryptographic proof-of-identity and/or a blockchain address for John Doe). The transaction 506 may also include an indication that the transaction 506 includes a request to store user data. The transaction 506 may also include the user data (e.g., the encrypted user data) and/or a CID for accessing the user data within the decentralized file storage system. Additionally, the transaction 506 may include an indication of the number of copies of the user data to store. For example, if the user wants their data to persist for a long period of time without being taken down, the user may request that several storage centers store copies of the user data.

Additionally or alternatively, the transaction 506 may include a cryptographic hash of the transaction information including the encrypted user data (e.g., the CID), so that the encrypted user data is not stored in the distributed ledger.

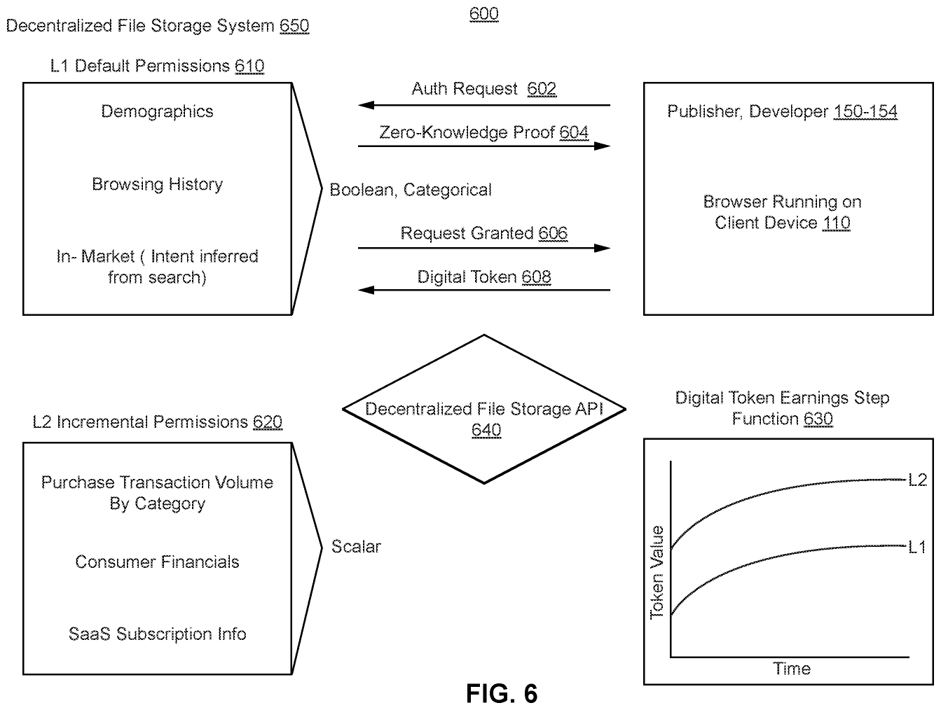

FIG. 6 illustrates an example combined block and message diagram 600 that includes an organization 150-154 such as a content publisher, game developer, etc., operating a web property within a browser application 116 of a client device 110. FIG. 6 also illustrates the data included in a decentralized file storage system 650, which may include user data accessible from Level 1 (L1) default permissions, such as Boolean or categorical data including demographic segment data, content preferences (e.g., browsing history preferences), behavioral attributes, such as, whether or not the user is in-market for a given purchase category or whether or not the user is eligible for certain market transactions which may be inferred from the user's search requests, etc. The data may also include user data accessible from Level 2 (L2) permissions, such as scalar data including purchase transaction volume data, consumer financial data, SaaS or entertainment subscription data, etc.

The client device 110 may communicate with or execute a node of the decentralized file storage system 650 to store user data and retrieve the user data from storage. An organization 150-154 may provide 602 an authorization request to the client device 110 via a decentralized file storage application programming interface (API) 640, for example when the user navigates to a web property of the organization 150-154 via the browsing application 116 or another application executing on the client device 110. The authorization request may include a permissions dialog sent through an SDK executing on the web property and/or via the decentralized file storage API 640 invoked within the web property.

The authorization request may include L1 requests for Boolean and/or categorical data. In some implementations, the user may select user controls to select which L1 requests to respond to with L1 permissions. The client device 110 may then generate 604 zero-knowledge proofs for the granted requests to cryptographically prove that the user has a particular attribute or demographic condition included in each L1 permission. Then the client device 110 transmits the zero-knowledge proofs to the organization 150-154 indicating which L1 permissions are provided 606. The organization 150-154 may then verify the zero-knowledge proofs and the organization 150-154 or the browsing service may provide 608 a particular number of digital tokens based on the type and/or number of L1 permissions provided.

In response to granting the L1 requests, the organization 150-154 may provide additional L2 requests for scalar data, such as purchase transaction volume data, consumer financial data including balances on consumer credit products, SaaS or entertainment subscription data including the number of streaming services the user subscribers to, etc. The scalar data may include the actual user data rather than a cryptographic proof that a user has a particular attribute or demographic condition. In some implementations, the user may select user controls to select which L2 requests to respond to with L2 permissions. The client device 110 may then obtain a shard of the user data that is responsive to the request for each L2 permission. For example, if the L2 request is for purchase transaction volume data, the client device 110 may obtain a shard of the user data that includes the number of purchases made by the user and/or the total amount of the purchases. Then the client device 110 transmits the shard(s) to the organization 150-154 indicating which L2 permissions are provided. The organization 150-154 or the browsing service may provide a particular number of digital tokens based on the type and/or number of L2 permissions provided.

The digital token earnings step function 630 illustrates a graph of the number of digital tokens that the user will receive over time for L1 permissions and L2 permissions. As indicated in the graph, the number of digital tokens to provide to the user is a function of time, the permission level (L1, L2) provided by the user, and/or the number and type of permissions provided at each permission level. For example, for L1 permissions the number of digital tokens may increase linearly over time, quadratically, polynomially, exponentially, as a step function, or in any suitable manner. Each L1 permission may be mapped to a different number of digital tokens, such that for example, the user may receive 2 digital tokens for providing information regarding a particular demographic segment and 5 digital tokens for providing information regarding a particular browsing preference.

For L2 permissions, the number of digital tokens may also increase linearly over time, quadratically, polynomially, exponentially, as a step function or in any suitable manner. However, the organization 150-154 or browsing service may provide more digital tokens for L2 permissions than for L1 permissions, such that for example, the organization 150-154 or browsing service provides a larger initial number of digital tokens for L2 permissions than for L1 permissions. Each L2 permission may be mapped to a different number of digital tokens, such that for example, the user may receive 8 digital tokens for providing information regarding the user's purchase transaction volume for a particular purchase category and 12 digital tokens for providing information regarding the user's consumer financial data.

The function for determining the number of digital tokens provided over time for L1 permissions may be similar to or the same as the number of digital tokens provided over time for L2 permissions. In some implementations, each time the user provides updated user data for a particular type of permission, the user receives additional digital tokens. For some types of permissions, the user may periodically provide updated user data such as the user's purchase transaction volume, whereas for other types of permissions, the user may not provide updated user data or may provide updated user data less frequently such as the user's age group or marital status.

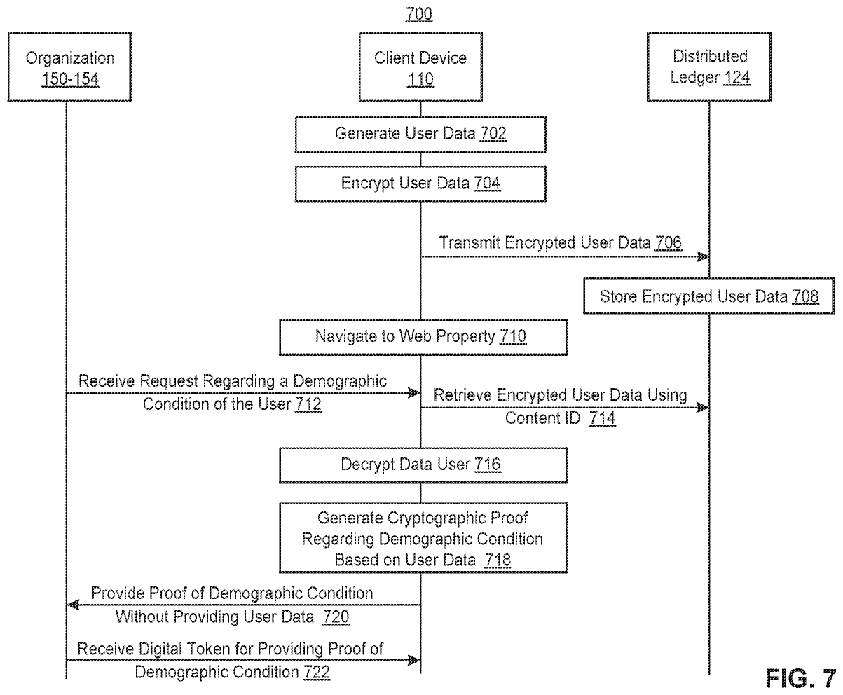

FIG. 7 illustrates an example message diagram 700 of an interaction between a client device 110, an organization 150-154, and a distributed ledger 124 to provide proof of an attribute or demographic condition without revealing sensitive information. The client device 110 generates 702 user data, for example while executing a browser application 116. More specifically, the user data may be obtained and/or generated based on user input, such as the user interacting with user controls (e.g., a drop-down menu, a free-form text field, etc.) to enter demographic data or user preference data. The user data may also be obtained and/or generated based on the user's browsing data, such as the user's purchase history, search queries, web interactions, etc. Additionally, the user data may be obtained and/or generated based on the user's application data, such as the user's interactions with various applications or web properties.

The client device 110 may encrypt 704 the user data and provide 706 the encrypted user data to validating network nodes of a distributed ledger network maintaining a distributed ledger 124 for a decentralized file storage system. In other implementations, the distributed ledger 124 is a permissioned distributed ledger where only authorized entities can access user data stored at the decentralized file storage system. In these implementations, the user data may not need to be encrypted. In any event, storage centers acting as validating network nodes within the distributed ledger network store 708 the encrypted user data.

When the user navigates 710 to an organization platform or web property of a third-party organization 150-154 via the browsing application 116 or another application executing on the client device 110, the organization 150-154 may provide 712 a request (e.g., an authorization request) for a particular attribute of the user, for example by invoking a decentralized file storage API. The particular attribute may be a demographic condition, such as whether the user is a homeowner, likes outdoor activities, has kids, etc.

In some implementations, the user may provide an indication that the user wants to respond to the request, for example in exchange for a digital token. The request may include L1 requests for Boolean and/or categorical data. In some implementations, the user may select user controls to select which L1 requests to respond to with L1 permissions. As a result, the user may consent to allow the web property to query the client device 110 for proof that the user has the particular attribute or satisfies the demographic condition.

Then the client device 110 may obtain 714 and/or decrypt 716 the user data from the decentralized file storage system. To respond to the request, the client device 110 may generate 718 cryptographic proof that the user has the particular attribute or satisfies the demographic condition, for example using a zero-knowledge proof. Zero-knowledge proofs allow a prover (e.g., the client device 110) to prove to another participant (e.g., the organization 150-154) that a certain statement is true over a private input without disclosing any other information from that input other than whether the statement is true or not. Zero-knowledge proofs allow the organization 150-154 to accept cryptographic proof that a user has a particular attribute or satisfies a demographic condition without revealing the user data. Zero-knowledge proofs can also be used to prove that a user has a particular type of user data without revealing the user data, or that a user has a particular attribute or satisfies a demographic condition without revealing the identity of the user.

For example, the client device 110 can prove the user data is within a particular range (e.g., the user is at least 21 years old, the user's annual income is greater than $50,000, the user has purchased at least one item from a particular store, etc.) by obtaining a random seed and generating a signed proof statement using a hash chain along with encrypted user data. The client device 110 then transmits the signed proof statement with the encrypted user data to prove that the user data is within the particular range.

The proof statement may be calculated by hashing the random seed (e.g., using a SHA-256 hashing algorithm) N times, where N is based on the difference between the minimum or maximum in the range and the actual value in the user data. For example, if the client device 110 is proving that the user is at least 21 years old and the user is 25, the client device 110 may hash the random seed 4 times to generate the proof, and sign the proof with a cryptographic private key. The client device 110 may also hash the random seed M times to generate encrypted user data, where M is based on the actual value in the user data. For example, the client device 110 may hash the random seed 25 times. Then the client device 110 sends the proof statement and the encrypted user data to the organization 150-154. The organization 150-154 verifies the cryptographic signature included in the proof statement. The organization 150-154 also hashes the proof Z times, where Z is the minimum or maximum in the range. For example, the organization 150-154 may hash the proof 21 times to generate a verification. Then the organization 150-154 compares the verification to the encrypted user data. Because the user's actual age, M is Z+N, the encrypted user data generated by hashing the random seed M times should equal the verification generated by first hashing the random seed N times to generate the proof and then hashing the random seed Z times. Also, because a hash function is a one-way function, it cannot be undone to uncover the original seed and/or the actual age. If the verification and the encrypted user data are the same, the organization 150-154 determines that the client device 110 has proved that the user data is within the particular range.

This is one example of a zero-knowledge proof for ease of illustration only. Zero-knowledge proofs may be generated in any suitable manner to cryptographically prove that the user has the particular attribute or satisfies a demographic condition without revealing the user data, that a user has a particular type of user data without revealing the user data, or that a user has a particular attribute or satisfies a demographic condition without revealing the identity of the user. For example, to prove that the user has a particular type of user data without revealing the user data, the client device 110 may generate a cryptographic proof which may be the same as or similar to proof of replication or proof of retrieval as described above. In another example, to prove that a user has a particular attribute or satisfies a demographic condition without revealing the identity of the user, the user be assigned a public key/private key pair in a distributed ledger network. The user may sign the indication of the particular attribute or demographic condition with the a cryptographic private key and provide proof to the organization 150-154. The organization 150-154 may then verify the cryptographic signature included in the proof statement to verify that the indication of the particular attribute or demographic condition came from the user without obtaining identity information for the user.

In any event, the client device 110 then provides 720 the cryptographic proof to the organization 150-154 without providing the user data. In some implementations, in response to providing the cryptographic proof, the client device 110 may receive 722 a particular number of tokens at a distributed ledger address maintained by a digital wallet 118 executing on the client device 110 from the organization 150-154.

In some implementations, the organization 150-154 may also provide L2 requests for scalar data. The user may select user controls to select which L2 requests to respond to with L2 permissions. Then the client device 110 may respond to the L2 requests by obtaining a shard of the user data that is responsive to each L2 request. For example, if the L2 request is for purchase transaction volume data, the client device 110 may obtain a shard of the user data that includes the number of purchases made by the user and/or the total amount of the purchases. Then the client device 110 transmits the shards to the organization 150-154. In some implementations, in response to providing the shards, the client device 110 may receive a particular number of tokens at a distributed ledger address maintained by a digital wallet 118 executing on the client device 110 from the organization 150-154.

Also in some implementations, the browsing service may generate and deploy a smart contract on a distributed ledger network which is configured to receive requests for user attributes or demographic conditions from organizations 150-154 and automatically transmit digital tokens to users based on responses to the requests. For example, the smart contract may require an organization 150-154 to provide a particular number of digital tokens to the smart contract in exchange for the smart contract transmitting requests to users for user attributes or demographic conditions. Then in response to receiving cryptographic proof from a user that the user has the particular attribute or satisfies the demographic condition, the smart contract provides a number of digital tokens to an address maintained by a digital wallet application 118 executing on the user's client device 110, for example in accordance with the digital token earnings step function 630.

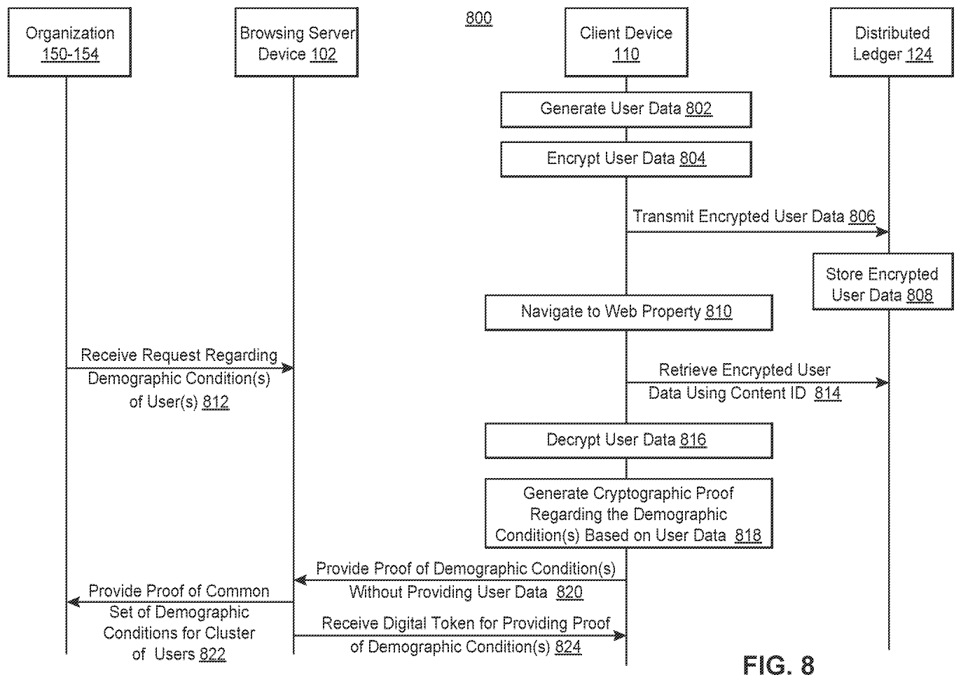

FIG. 8 illustrates another example message diagram 800 where a browser server device 102 acts as an intermediary between the client device 110 and the organization 150-154. In this example, rather than the organization 150-154 communicating directly with the client device 110, the organization 150-154 provides 812 requests for an attribute(s) or a demographic condition(s) from users of the browsing service. The browsing server device 102 may then provide these requests to client devices 110 and in turn, may receive cryptographic proofs 820 from the client devices 110 of various attributes or demographic conditions.

In some implementations, the browsing server device 102 may cluster the users based on the various attributes or demographic conditions that are shared amongst a subset of the users. More specifically, the browsing server device 102 may use a k-means clustering algorithm to segment the users into clusters each having a shared set of attributes or demographic conditions. For example, the browsing server device 102 may identify that a cohort of 100 users executing the browser application are single men under 40 years old. The browsing server device 102 may then provide 822 the common set of attributes or demographic conditions for the cohort of users to the web property for the organization 150-154. Additionally, the browsing server device 102 may provide 824 digital tokens to the users for providing proof of the attributes or demographic conditions.

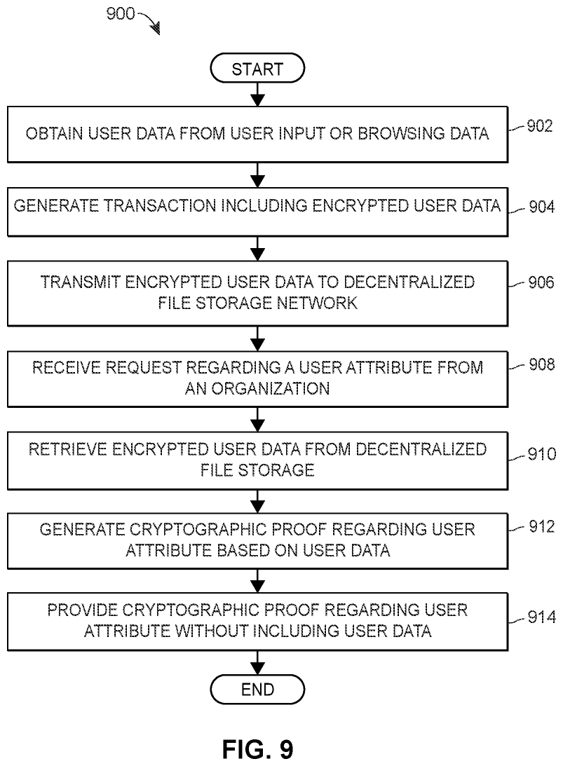

FIG. 9 illustrates a flow diagram representing an exemplary method 900 for providing information regarding user data to an organization without revealing sensitive information. The method 900 may be executed by a client device 110 executing a browser application 116.

At block 902, user data is obtained from user input, application data, or browsing data. The user data may include demographic data, such as the user's age, gender, address, ethnicity, nationality, income, marital status, level of education, etc. The user data may also include the user's interests, such as shopping preferences, preferred restaurants, preferred travel destinations, preferred activities, preferred sports teams, etc. Additionally, the user data may include the user's purchasing preferences, such as the types of goods or services the user purchases, the purchase price of the goods or services, the frequency in which the user makes purchases, the quality of the good or services, etc.

At block 904, the client device 110 generates a transaction including the user data to store in a distributed ledger for a decentralized file storage system. The transaction may include encrypted user data and/or a hash of the user data such as a CID. The client device 110 then transmits the transaction to a validating network node in the distributed ledger network to store the user data at a storage center participating in the decentralized file storage system (block 906).

Then at block 908, the client device 110 receives a request (e.g., an authorization request) from an organization 150-154 for a user attribute or demographic condition regarding the user. For example, the organization 150-154 may provide the request when the user navigates to a web property of the organization 150-154 via the browsing application 116 or another application executing on the client device 110. The request may be for the user to indicate whether the user is a homeowner, likes outdoor activities, has kids, etc.

In some implementations, the user may provide an indication that the user wants to respond to the request, for example in exchange for a digital token. Then the client device 110 may obtain and/or decrypt the user data from the decentralized file storage system (block 910). To respond to the request, the client device 110 may generate cryptographic proof that the user has the particular attribute or satisfies the demographic condition, for example using a zero-knowledge proof (block 912). Then the client device 110 may provide the cryptographic proof to the web property of the organization 150-154 without providing the user data (block 914). In some implementations, in response to providing the cryptographic proof, the client device 110 may receive a particular number of digital tokens at a distributed ledger address maintained by a digital wallet 118 executing on the client device 110 from the organization 150-154 or the browsing server device 102.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A method for providing information regarding user data to an organization without revealing sensitive information, the method comprising:
obtaining, by one or more processors, user data describing one or more attributes of a user from user input, application data, or browsing data;
generating, by the one or more processors, a transaction including the user data, the transaction stored in a distributed ledger for decentralized file storage, wherein the distributed ledger is maintained by a network of participants;
transmitting the transaction to at least one other participant in the distributed ledger network;
receiving, by the one or more processors, a request from an organization regarding a particular attribute of the user; and
in response to the request, providing, by the one or more processors to the organization, cryptographic proof of information regarding the particular attribute stored in the decentralized file storage without revealing the user data.

2. The method of claim 1, wherein the user data includes at least one of: demographic data, content preferences, or behavioral attributes for the user.

3. The method of claim 2, wherein the request regarding the particular attribute is a request regarding a particular demographic condition corresponding to the particular attribute of the user, and the cryptographic proof of information is a cryptographic proof that the user meets criteria for the particular demographic condition without revealing the user data.

4. The method of claim 3, further comprising:
obtaining a plurality of cryptographic proofs of information regarding the particular attribute for a plurality of users forming a cohort; and
providing, to the organization, an indication that the cohort meets the criteria for the particular demographic condition without revealing the user data for each user.

5. The method of claim 4, further comprising:
obtaining cryptographic proofs of information for a plurality of users regarding a plurality of demographic conditions;
clustering the plurality of users in accordance with the plurality of demographic conditions; and
providing, to the organization, a common set of demographic conditions for a cluster of the plurality of users.

6. The method of claim 1, wherein generating the transaction including the user data including encrypting the user data.

7. The method of claim 1, wherein generating the transaction includes generating a cryptographic signature for the user and augmenting the transaction with the cryptographic signature.

8. The method of claim 1, wherein generating the transaction includes generating the transaction including a cryptographic hash value corresponding to the user data.

9. A computing device for providing information regarding user data to an organization without revealing sensitive information, the computing device comprising:
one or more processors; and
a non-transitory computer-readable medium coupled to the one or more processors and storing instructions thereon, that when executed by the one or more processors, cause the computing device to:
obtain user data describing one or more attributes of a user from user input, application data, or browsing data;
generate a transaction including the user data, the transaction stored in a distributed ledger for decentralized file storage, wherein the distributed ledger is maintained by a network of participants;
transmit the transaction to at least one other participant in the distributed ledger network;
receive a request from an organization regarding a particular attribute of the user; and
in response to the request, provide, to the organization, cryptographic proof of information regarding the particular attribute stored in the decentralized file storage without revealing the user data.

10. The computing device of claim 9, wherein the user data includes at least one of: demographic data, content preferences, or behavioral attributes for the user.

11. The computing device of claim 10, wherein the request regarding the particular attribute is a request regarding a particular demographic condition corresponding to the particular attribute of the user, and the cryptographic proof of information is a cryptographic proof that the user meets criteria for the particular demographic condition without revealing the user data.

12. The computing device of claim 11, wherein the instructions further cause the computing device to:
obtain a plurality of cryptographic proofs of information regarding the particular attribute for a plurality of users forming a cohort; and
provide, to the organization, an indication that the cohort meets the criteria for the particular demographic condition without revealing the user data for each user.

13. The computing device of claim 12, wherein the instructions further cause the computing device to:
obtain cryptographic proofs of information for a plurality of users regarding a plurality of demographic conditions;
cluster the plurality of users in accordance with the plurality of demographic conditions; and
provide, to the organization, a common set of demographic conditions for a cluster of the plurality of users.

14. The computing device of claim 9, wherein the user data in the transaction is encrypted.

15. The computing device of claim 9, wherein to generate the transaction, the instructions cause the computing device to generate a cryptographic signature for the user and augment the transaction with the cryptographic signature.

16. The computing device of claim 9, wherein the transaction includes a cryptographic hash value corresponding to the user data.

17. A non-transitory computer-readable medium coupled to one or more processors and storing instructions thereon, that when executed by the one or more processors, cause the one or more processors to:
obtain user data describing one or more attributes of a user from user input, application data, or browsing data;
generate a transaction including the user data, the transaction stored in a distributed ledger for decentralized file storage, wherein the distributed ledger is maintained by a network of participants;
transmit the transaction to at least one other participant in the distributed ledger network;
receive a request from an organization regarding a particular attribute of the user; and
in response to the request, provide, to the organization, cryptographic proof of information regarding the particular attribute stored in the decentralized file storage without revealing the user data.

18. The computer-readable medium of claim 17, wherein the user data includes at least one of: demographic data, content preferences, or behavioral attributes for the user.

19. The computer-readable medium of claim 18, wherein the request regarding the particular attribute is a request regarding a particular demographic condition corresponding to the particular attribute of the user, and the cryptographic proof of information is a cryptographic proof that the user meets criteria for the particular demographic condition without revealing the user data.

20. The computer-readable medium of claim 19, wherein the instructions further cause the one or more processors to:
obtain a plurality of cryptographic proofs of information regarding the particular attribute for a plurality of users forming a cohort; and
provide, to the organization, an indication that the cohort meets the criteria for the particular demographic condition without revealing the user data for each user.
